(19) United States
(12) Patent Application Publication
(10) Pub. No.: US 2002/0141760 A1
(43) Pub. Date: Oct. 3, 2002

(54) Transverse reflective-protective contact eye lenses and coating for conventional face-mounted apparatus, manufacturing method and kit

(76) Inventor: Joseph A. Resnick, Crystal River, FL (US)

Correspondence Address: D. Sullivan, Esq., 150 Cheney Ct., New Kensington, PA, 15068, US

(21) Appl. No.: 09/821,634

(22) Filed: Mar. 29, 2001

(51) Int. Cl. G03B 1/00

(52) U.S. Cl. 396/661

(57) ABSTRACT

A device comprising a means and method, and a means and method of presentation to a human body component, as in the form of an application or a coating, or another form, such as a pre-formed lense, to and for protecting the human eye or other organs or parts of the human body from injury from elecrtomotive-force weapons, radiant energy weapons or sources, light or sound powered devices or weapons, or from any other energy sources, such as the Sun, or from the flashes of high-intensity camera strobe lights, for example, which may be capable of providing sufficient radiant energy, directed energy, for example, LASER, in the direction of the wearer, to cause temporary blindness, vertigo, loss of consciousness, confusion, disorientation or other undersirable physical conditions. The device comprises a singular layer, or may comprise a matrix or matrixes containing microspheres or nanospheres containing adsorptive substances or reflective substances, and miniature heating or cooling devices for the purpose of maintaining homeostasis in an organ, or for warming or cooling the body component or part or parts of the body, the human eye, for example, or other parts of the human body, the ears, for example (sound)

### A RELATED APPLICATION

The instant application is related to U.S. patent application Ser. No. 09/204,622 entitled, PHOTOGRAPHIC COUNTERMEASURE DEVICE AND METHOD filed on Dec. 1, 1998 by Dr. Joseph A. Resnick, Inventor. Counsel for Dr. Resnick is Mr. Daniel A. Sullivan, Jr. Esq. Reg. #25068. This information disclosure is provided for information and disclosure purposes only and for the benefit of the Examiner. The Instant Application should not be considered reliant upon such disclosure in terms of claims of filing/issuance dates. This application is presently in the status of “interference”, as the USPO has, apparently, issued a patent to a group of indivuduals that this Inventor disclosed information to at the “Invention Convention” held in Long Beach, Calif. in 1999 . . . and on the basis of that information the alleged “inventors” filed for and “accellerated” a patent application . . . and same has issued . . . which is hereby again disputed herein and made part hereof for future reference. Therefore, the instant Application should not be considered to be a Continuation-In-Part, rather it is a separate and independent invention.

### BACKGROUND

As early as 1508 Leonardo da Vinci illustrated the concept of utilizing contact lenses as a method of improving vision. In 1823 British Astronomer Sir John Herschel conceptualized a practical lens design. In 1887 the first contact lens was manufactured from glass to fit the human eye. In 1937 contact lenses were made from plastic to fit the human eye. In 1948 plastic lenses were made to fit only the cornea of the human eye. In 1971 the first soft-contact lens was made. In 1978 the oxygen-permeable contact lens was introduced. In 1981 the US Food and Drug Administration (“FDA”) approved the use of the first extended wear contact lens which enabled the user to wear the lens fro extended periods of time, usually over night. In 1986 extended wear, over-night contact lenses became widely available. In 1987 a disposable, soft-contact lens was developed and became available. In 1987 oxygen-permeable, or gas-permeable lenses became available utilizing advanced polymers, such as flourosilicone acrylate materials. A variety of uses are recommended for wearers of these appliances from Toric conditions to the more-recently available cosmetic lenses which enable the wearer to choose a particular eye color, for example. Some lenses are also available for actors for use in movies and on the stage which enable the wearer to have the eyes appear to glow or to take on other desired characteristics. For the most part, contact lenses are used to correct Toric or myopic conditions. Some types of contact lenses are used as temporary prostheses, such as in the science of Orthokeratology, wherein a device is used to constrict desired areas of the cornea thereby altering the refractive properties, temporarily, by altering the shape of the cornea.

### INTRODUCTION

The instant application and invention relates to a means, method and manufacture of a contact lenses designed to be worn on the user's eye for the purpose of providing protection from the effects of repeated exposure to optical stimulation of the optic nerves and central nervous system, or brain, as a result of repeated exposure to flashes of radiant light commonly associated with the strobe flashes produced by cameras, or by exposure to radiation from other sources, such as the Sun, or from next-generation LASER or spectral energy weapons, or any type of electromotive force weaponry, by providing and incorporating, singularly or in combination, both methods of reflective means and/or adsorptive means utilizing Radar-Attenuating Materials (“RAM), such as Molybdenum Disulfide (“MOS2”), or other discrete microelectronic devices, such as electromotive force (“EMF”) counter counter-measure devices, in order to protect the wearer from suffering injuries or harm as a result of exposure to such occurrences. In a less severe example, celebrities and movie stars are exposed to hundreds of flashes during special events such as the Screen Actor's Guild Award ceremonies, Oscar presentations and awards, etc. During such events and as a result of repeated exposure to the flashes generated by cameras used by members of the media and the Paparazzi, some celebrities experience physical side effects as a result of over stimulation to the optic nerves and central nervous system (brain), such as disorientation, temporary blindness, vertigo, nausea/vomiting, etc. One of the objects of the instant invention is to prevent such physical onsets of discomfort, symptoms and possible side effects, such as development of brain tumors, as a result of such exposure to unnatural light sources. The instant invention is enabled through alteration and improvement of conventional contact lenses by incorporation of the microspheres or nanospheres into the actual lens during manufacture through fabrication of a new shaped matrix incorporating microspheres (including nanospheres) containing reflective or adsorptive substances, or by the application of a coating comprising substrate, carrier microspheres, binder and chemicals, in a matrix or comprising layers of coating comprising a matrix, or comprising a series of matrixes, to be applied as a coating to existing lenses or new manufactures, or alternately to both.

Alternatively, injuries to soldiers or other personnel who cold be blinded or immobilized or nullified by high-intensity LASER or energy-radiant spectral-specific weapons, and consequently be defeated or immobilized, could be prevented while wearing the proposed eye protection system.

It has been well-established in the literature that exposure by humans to certain electro-optical frequencies can cause both injury (Grand Mal Seizures) and death. Another of the objects of the instant invention is to provide both the means and method of preventing such undesirable injuries and subsequent deaths.

### DISCLOSURE OF THE INVENTION

The instant invention comprises a typical permeable, or semi-permeable, or gaspermeable (breathable), or conventional glass, or hard contact eye lenses as taught in U.S. Pat. Nos. 5,891,932 or 4,865,439, for example. These types of contact eye lenses have been the subject of much study and research and their value to users has been well established by the medical, scientific and academic communities. The novel contact eye lens proposed by the Instant Invention differs from conventional contact eye lenses in that the instant invention now provides a means and method of placing both reflective coatings on the transverse or inner surface of the contact eye lenses, in one embodiment, for example, or by incorporating an energy-absorbent substance directly into the lens (via microspheres or nanospheres) during the manufacture process, or through creation of a matrix or matrixes containing energy-absorptive substances or energy reflective substances, or combination thereof, which enables the wearer to protect against potentially harmful radiant energies, whether naturally produced from the Sun, for example, or from directed energy sources such as LASER weapons, or other such EMF or specrta-specific Less-Than-Lethal (“LTL's) weapons, such as sound or light guns in present use and experimentation by the U.S. Marine's Light Urban Assault Task Forces, Quantico, Va., USA. Reference is now made to U.S. patent application Ser. No. 09/312,535 Filed on May 24, 1999 Entitled, Close-Contact Counter-Measure Garment, being examined in Art Unit 3644 by Examiner J. Eldred, and incorporated herein by reference as if by its entirety.

The coating may be comprised of or comprise biologically-compatible substances and comprise or be comprised of reflective substances or energy-absorptive substances, such as MOS2 which may be microencapsulated in polymeric or silicon-based substances, such as plastic, methyl methacrylate, or various glass substances, or typically made of microscopic-sized glass beads first described by Resnick in U.S. Pat. No. 4,424,911 which is now incorporated herein by reference or also described by Resnick in U.S. Pat. No. 7,523,757 and also incorporated herein by reference. Such fabrication and incorporation should be considered easily accomplished by persons of reasonable skill in the art and should be considered illustrative, rather than limiting.

### THE SPECIFICATION

To reduce the invention to practice I produced a quantity of microscopic-sized spheres (both microspheres and nanaospheres) with an apparatus I invented and concerning which I made formal Letters Patent Application but decided not to issue same for secrecy reasons. Reference to that Patent Application is made as U.S. patent application Ser. No. ______, incorporated herein by reference and made part hereof. I do this for the benefit of the Examiner's potential concerns regarding operability of the claimed and Instant Invention. Further to assuage any potential concerns regarding my ability to produce microspheres or nanaospheres, I also hereby include reference to my

U.S. Pat. No. 5,807,724 which also utilizes microspheres or microcapsules in bringing that invention into practice and which resulting products are in worldwide use.

Using the apparatus I fabricated a quantity of microcapsules from a polymeric substance, GELTRAN®, which I obtained from 3M Chemicals Corporation, Minneapolis, Minn. USA. I also experimented with Kelco® which was supplied to me free of charge by colleagues at Merck & Company, Inc., Philadelphia, Pa. USA. The microspheres I produced had an approximate diameter of 0.25 micrometers (“uM”). Using the above mentioned and incorporated apparatus I was able to place a small quantity of a reflective substances, for example, Chromic Oxide, Silver Oxide and Ferric Oxide, into the microcapsules during the manufacture process. Of course, polymeric chemical deposition methods may be more suitable to accomplish one or more of the goals of this invention particularly when considering mass-production or for mass marketing of the new products which may result from this research, or for the production of sheet material containing microspheres in carrier or binder from which a matrix or matrixes may be fabricated and subsequently formed to meet the specific shape of the individual human cornea. In that regard, any number of methods available to enable application of coatings to surfaces or fabrication of a matrix or matrixes, whether natural or synthetic, and incorporation of the microspheres and chemical, or microspheres or nanaospherse containing chemicals and solutions, for example as I teach in the issued U.S. patents listed above, should be considered as being included herein as if by entirety and further being capable of reduction to practice by artisans or persons of reasonable skill in such respective arts and further considered illustrative rather than limiting.

I also produced a quantity of microspheres and nanospheres containing Molybdenum Disulfide (MOS2) as I taught in my issued U.S. Pat. No. 5,523,757 which I mentioned above and which is incorporated herein by reference. I set these aside for later use and application as a coating or for fabrication of a matrix or matrixes to be applied to conventional Rigid Gas-Permeable Lenses (“RGP” lenses), conventional soft lenses, or Toric lenses to be used in my experiments.

After producing a quantity of microspheres I obtained a quantity of disposable contact lenses, such as those produced by: ______ of ______ for experimentation. To these I first applied a coating consisting of 0.20 micrograms (“uG”) of Methyl Methacrylate, which I obtained from my laboratory stores but which had previously been obtained from Mr. Joe Pierce of Xenon Corporation of Boston, Mass. USA, in combination with 0.005 uG of nanocapsules which I produced which contained a quantity of chromic oxide, which I obtained from my own laboratory stores having purchased same from Fisher Scientific Corporation, Pittsburgh, Pa. USA. A like quantity of nanospheres (or microspheres) was manufactured and contained a quantity of molybdenum disulfide which was also obtained from my laboratory stores, which had been previously purchased from Aldrich Chemicals, Inc. of Milwaukee, Wis. USA, which I also used in reducing to practice my U.S. Pat. No. 5,523,757 which was tested for me at the US Army Low Observables Testing Laboratory at Fort Belvoir, Va. USA.

I then produced a sheet of the combined substrate carrier containing microspheres/nanospheres in combination with energy-reflective substances, such as silver oxide, which I obtained from my laboratory stores but which had been previously purchased from Fisher Scientific, Inc. of Pittsburgh, Pa. USA, by utilizing the above-mentioned apparatus in the containment compartment by positioning a conventional-type metal appliance, such as a cookie sheet having dimension of 18 inches by 24 inches, and which I borrowed from my wife's kitchen, on a set of saw horses within the sealed containment compartment. Prior to such placement of the cookie sheet device into the compartment I first applied a misted layer of PAM® (a food-grade and medical-grade product approved by the US FDA) cooking oil which has biologically-compatible properties and is a non-irritant to the human eye. Other substances may also be used, such as a wide variety of biologically-compatible polymers produced by 3M Corporation of Minneapolis, Minn. USA. But for the purposes of this small experiment I chose to use easily and readily accessible materials . . . and this substance was determined to be more than adequate for initial experimentation. This (misting) was accomplished by following the written label instructions on the product. I then placed a layer of parchment paper on top of the cookie sheet containing the coating of oil. I then applied a similar quantity of the same product to the parchment paper. This was done to prevent the methyl methacrylate carrier and microspheres which I was about to apply during manufacture utilizing my apparatus, from sticking to the surfaces both during and after manufacture of the microspheres and methyl methacrylate carrier to the parchment paper on the cookie sheet. Utilizing the above mentioned apparatus and process I produced a thin sheet of substrate containing microcapsules. The sheet had an overall thickness of 0.0004 millimeters (“mils.”). After producing the sheet I placed the cookie sheet containing the parchment paper with finished sheet-product into my Alsco® laboratory-grade incubator to complete the air-drying process and to protect the new product from contamination by air-borne substances. The new material was air-dried for approximately 14 hours at 88 degrees Fahrenheit.

At a later time I measured the diameter of the previously purchased, disposable contact lenses, utilizing the dissecting microscope I have in my laboratory, and determined their size to be approximately one centimeter (1 cm) in length by 0.75 centimeters (0.75 cm) in width. At a later time I used a conventional hand-held punch device, such as that manufactured by ______ of ______, which I purchased many years ago for use in the laboratory, to produce approximately 12 (one dozen) prototype eye lenses. These were then placed in an isotonic solution (3% Saline Solution) to protect them from contamination prior to my use in experimentation.

It occurred to me during my research and experimentation efforts that it may desirable to produce the new substances in sheets which I could utilize to construct new appliances, each of which could have different desired characteristics. For example, I produced one sheet containing the reflective substance, silver oxide, which is essentially the same material used to make the reflective surfaces/coating in mirror devices. This embodiment could be used, singularly, or in combination with additional sheets to achieve a desired result, protection from flashes of camera strobe lights, for example, both of which are new and useful aspects of the instant invention and for which application is made.

In yet another embodiment I made a sheet of material containing MOS2, a substance which has the ability to absorb electronic signatures. And in this embodiment, used either singularly or in combination, could be used to thwart assault by EMF and energy-directed weapons, simply by combining one-layer of sheet containing substrate and silver oxide, for example, with an additional layer of sheet containing molybdenum disulfide, thus resulting in an additional new and useful device.

And in yet, another embodiment, I manufactured a sheet containing miniaturized cooling devices comprised of microspheres taught in my U.S. Pat. No. 5,163,504, CONTAINER HEATING OR COOLING DEVICE AND BUILDING MATERIAL which issued to me on Nov. 17, 1992 and which is incorporated herein by reference as if by entirety. Such a configuration might be necessary to dissipate the heat adsorbed by the miniature heat exchangers during their operation as described in my issued US Patent and demonstrated as operable by the US Army Low Observables Lab at Fort Belvoir. One can easily envision this necessity in futuristic war scenarios where high-intensity vision-disabling devices might very well be used. In that regard I now claim an additional new and useful aspect to the instant invention, that being protection of the human eye (vision organ) from injury by exposure to submillimeter generation of heat, from microwave signatures, or other broad-band electronic signatures, by incorporation and utilization of the tenets of my issued U.S. Pat. No. 5,163,504 referenced and incorporated above. Such incorporation should be considered illustrative, rather than limiting, and easily accomplished by persons of reasonable skill in the art. Simply put, if you use the devices and methods I described in my earlier work . . . you can easily reduce these devices to practice. And they work . . . . so says the US Army's testing labs at Ft. Belvoir, Va.

In essence, the above descriptions and embodiments can be utilized to fabricate a new generation of protective eye devices. The new generation of devices may be fabricated by taking one layer of substrate containing microcapsules/chemicals/gasses (for example, it is possible to utilize exotic fluoride substances in such microstructures to create a new-generation of night-vision lenses, for example, utilizing the human body's own electrical energy derived from Galvanic dossimetry to provide power to operate such systems . . . first conceptualized and described by Resnick in U.S. Pat. No. 4,571,739 and used as an alternate biological power source) and placing a second layer, or alternatively, multiple layers, one upon the other, to construct new and useful appliances, in a matrix or matrixes to enable the invention.

A further aspect of the invention is a novel chemical or gas delivery system which may be used in combination with the instant system to accomplish levage of the organ (eye) or to treat injuries by application of time-released substances directly onto the surface of the cornea or to the overall surface of the organ (eye), after or prior to injury, or during incidences of battle, for example, or while recovering from eye or facial surgery or injuries. I shall cause the filing of a separate patent application, without traverse, concerning this aspect of the invention, but mention it here, only to document discovery and concept dates as a matter of record.

### BRIEF DESCRIPTION OF THE DRAWINGS

FIG. 1 is a plan view of the invention comprising a sheet containing microspheres containing chemicals.

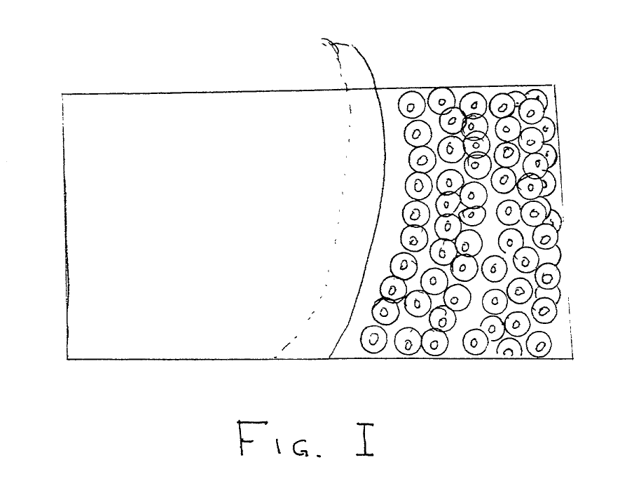

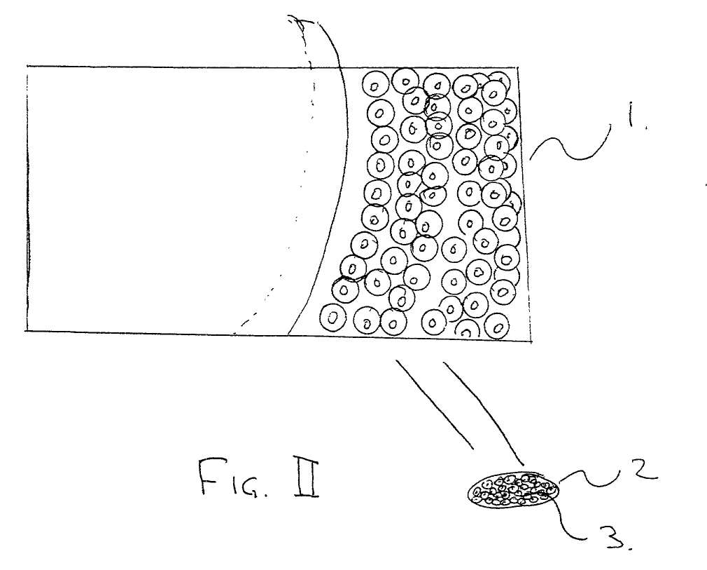

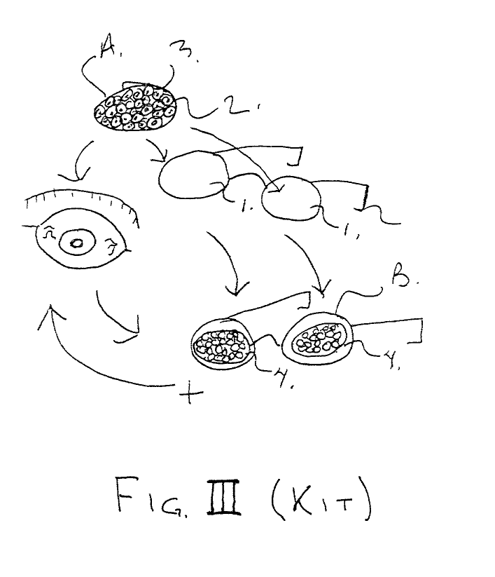

1. A protective device for the human eye comprising:
A. Microspheres or nanospheres containing chemicals, gasses, or combinations of chemicals and gasses, whether natural or man-made.
B. A method of producing microspheres or nanospheres in combination with carrier comprising natural or synthetic substances, for example, polymers, isomers, monomers, ionomers, fats, oligomers, lipids, waxes, natural or synthetic, or human cerumen.
C. Microspheres containing substances togehter comprising a matrix or matrixes for the purpose of protecting the human eye from injury due to readiation or flashes of radiant light, whether in the visible or non-visible spectrum.
D. Microspheres in substrate comprising sheets for the purpose of presenting combinations of microspheres/substrate/sheets to the human eye for the purpose of providing protection of human body components, including the eye, from injury.

2. The device of claim 1, comprising a method of presenting microspheres containing adsorptive or reflective, or heating and cooling properties, entropic or enthalpic, or drug delivery properties to a part or parts of the human body, to the eye.

3. The substance of claim 1, being natural or synthetic.

4. The substance of claim 1, being Molybdenum disulfide.

5. The substance of claim 1, being and comprising a miniature cooling device comprising microspheres containing sulphurized water, or heavy water, such as Hydrogen Peroxide USP, and containing at least 2% chelated sulphur, per dram.

6. The substance of claim 1, comprising microspheres containing at least 8% Sulphur by weight of deposition and transpiration.

7. The substance of claim 1, in microsphere/s being Hydrogen Peroxide.

8. The substance of claim 1, in microspheres being individually or in combination, Aluminum Oxide, Ferric Oxide, Aluminum Oxide or any combinations thereof.

9. A novel delivery system comprising microspheres, nanospheres, chemicals, natural and synthetic substances, for the purpose of protecting the human eye from injury.

10. A method of fabricating the invention to comprise a matrix containing microspheres.

11. A method of presenting a device containing matrix or matrixes to the human body or parts thereof for the purpose of protecting the human body from unwanted injury.

12. A method of presenting the invention, or parts of the invention, to the human body so as to deliver drugs or Unguentum (lubricants, for example) to injured parts of the body.

13. The device of claim 1, being comprised of biologically compatible materials such as MDX 4515 medical grade silicone.

14. A metod of placing the invention, now comprising a “coatng” on convention-type eyeglasses, such as popular-type “sunglasses”, and colored and non-colered, prescription or non-prescription lenses.
